(19) United States
(12) Patent Application Publication
(10) Pub. No.: US 2025/0379467 A1
(43) Pub. Date: Dec. 11, 2025

(54) DUAL-ALTERNATOR REGULATOR AND ALTERNATOR REGULATOR HAVING INTERNET CONNECTIVITY

(71) Applicant: Revatek LLC, Menomonee Falls, WI (US)

(72) Inventor: Gregory Revelle, Menomonee Falls, WI (US)

(21) Appl. No.: 19/231,736

(22) Filed: Jun. 9, 2025

Related U.S. Application Data
(60) Provisional application No. 63/657,131, filed on Jun. 7, 2024.

(51) Int. Cl. H02J 7/14; B60L 50/60; H04L 12/40

(52) U.S. Cl. CPC H02J 7/1423; B60L 50/66; H04L 12/40; H04L 2012/40215

(57) ABSTRACT

In one embodiment, a regulator is provided for regulating power supplied from two alternators to at least one battery bank. The regulator includes: a plurality of input ports for receiving alternator operating data from both the alternators and for receiving battery data from the battery bank; and a controller coupled to the plurality of input ports. The controller is configured to independently regulate each of the two alternators in response to the alternator operating data and the battery data; and manage and charge the at least one battery bank in response to the battery data. In another embodiment, a cloud-based system is provided that includes an asynchronous messaging system for receiving time-series and event data from a plurality of remote alternator regulators, and event-driven compute services for storing regulator device status, configuration history, and fault events in a metadata database, and storing historical time-series measurements in an analytical database.

### CROSS-REFERENCE TO RELATED APPLICATION

This application claims priority under 35 U.S.C. § 119(e) upon U.S. Provisional Patent Application No. 63/657,131, entitled “UNIVERSAL MULTIPLE ALTERNATOR AND BATTERY BANK MANAGEMENT SYSTEM FOR 12-48V APPLICATIONS” filed on Jun. 7, 2024, by Greg Revelle, the entire disclosure of which is incorporated herein by reference.

### TECHNOLOGICAL FIELD

The present invention relates to an alternator regulator and, more particularly, to an alternator regulator used in vehicles, boats, and recreational vehicles.

### SUMMARY OF THE INVENTION

According to one aspect of the invention, a regulator is provided for regulating power supplied from two alternators to at least one battery bank, the regulator including: an enclosure; a plurality of input ports on the enclosure for receiving alternator operating data from both of the two alternators and for receiving battery data from the at least one battery bank; and a controller disposed in the enclosure and coupled to the plurality of input ports, the controller configured to: independently regulate each of the two alternators in response to the alternator operating data and the battery data; and manage and charge the at least one battery bank in response to the battery data.

According to another aspect of the present disclosure, a regulator is provided for regulating power supplied from two alternators to a first battery bank and a second battery bank, the regulator including: an enclosure; a plurality of input ports on the enclosure for receiving alternator operating data from both of the two alternators and for receiving battery data from the two battery banks; and a controller disposed in the enclosure and coupled to the plurality of input ports, the controller configured to: independently regulate each of the two alternators in response to the alternator operating data and the battery data; and independently manage and charge each of the first and second battery banks in response to the battery data.

According to another aspect of the present disclosure, a cloud-based system for managing remote alternator regulators, the system including: an asynchronous messaging system for receiving time-series and event data from the remote alternator regulators; a metadata and device state database for storing frequently accessed data items like regulator device status, current configuration, user profiles, roles, permissions, and event summaries; a scalable analytical database for storing historical time-series measurements received from the remote alternator regulators; event-driven compute services triggered by incoming messages received by the asynchronous messaging system to process the time-series and event data by validating payloads, writing regulator device status, configuration history, and fault events to the metadata and device state database, the event-driven compute services further configured to store historical time-series measurements into the scalable analytical database, wherein the event-driven compute services are additionally configured for chronologically ordering data sessions for any of the remote alternator regulators that lack persistent time references; and an API gateway for providing remote viewing and deployment of configuration settings to the alternator regulators, the API gateway providing remote viewing in which visualization of multiple parameters, correlation of performance data with logged events including fault conditions and configuration changes, display of system parameters proximate to event occurrences, and data export are provided through a user interface.

These and other features, advantages, and objects of the present device will be further understood and appreciated by those skilled in the art upon studying the following specification, claims, and appended drawings.

### BRIEF DESCRIPTION OF THE DRAWINGS

The embodiments will now be described with reference to the following drawings, in which:

FIG. 1 is an electrical circuit diagram in block form of a first implementation of the present invention;

FIG. 2 is an electrical circuit diagram in block form of a second implementation of the present invention;

FIG. 3 is an electrical circuit diagram in block form of an alternator regulator that may be used in the implementations shown in FIGS. 1 and 2;

FIG. 4 is an electrical circuit diagram in block form of details of the first implementation shown in FIG. 1;

FIG. 5 is a top view of an alternator regulator including the electrical circuit shown in FIG. 3;

FIG. 6 is a block diagram of a cloud-based system architecture used to monitor and configure a plurality of alternator regulators; and

FIG. 7 is an example of an analysis page viewable on a web-based user interface as made available by the system shown in FIG. 6.

The components in the figures are not necessarily to scale, emphasis instead being placed upon illustrating the principles described herein.

### DETAILED DESCRIPTION OF EMBODIMENTS

For purposes of description herein, it should be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

The present disclosure relates to an alternator regulator. Present alternator regulators exist that regulate the power output from one alternator for charging a battery bank, which may include one or more batteries. In marine applications where a boat is powered by two engines and has two battery banks, each engine has one alternator for charging a respective one of the battery banks. For example, the starboard alternator charges the starboard battery bank while the port alternator charges the port battery bank. In this case, separate alternator regulators are provided for each alternator. According to one embodiment of the present invention, an alternator regulator is provided that regulates the power of both alternators while managing and charging one or more battery banks. This eliminates the need for separate alternator regulators for each alternator streamlining the charging system while providing numerous other advantages discussed below. The regulator supports a wide range of battery chemistries (lead acid, lithium) and system voltages (12-48V), offering flexibility and compatibility with various applications.

Recreational vehicles (RVs) may have a single engine with a single alternator and regulator while also having a generator for charging the house battery bank. Such generators require maintenance as well as gas. In addition, the generators take up valuable space and their weight impacts fuel efficiency of the RV. According to an embodiment of the present invention, a second alternator may be driven by the single engine and a single alternator regulator may be used to regulate the power from each of the two alternators in order to manage and charge multiple battery banks and thereby eliminate the need for a generator.

All gas-powered vehicles include an engine, an alternator, a battery and an alternator regulator. When such vehicles are part of a fleet of vehicles, it may be imperative to be able to monitor and diagnose the batteries and alternators. According to another embodiment of the present invention, a cloud-based system is provided for monitoring a plurality of remote alternator regulators. Data relating to the regulators, the batteries, and the alternators may thus be accessed remotely including historical trends.

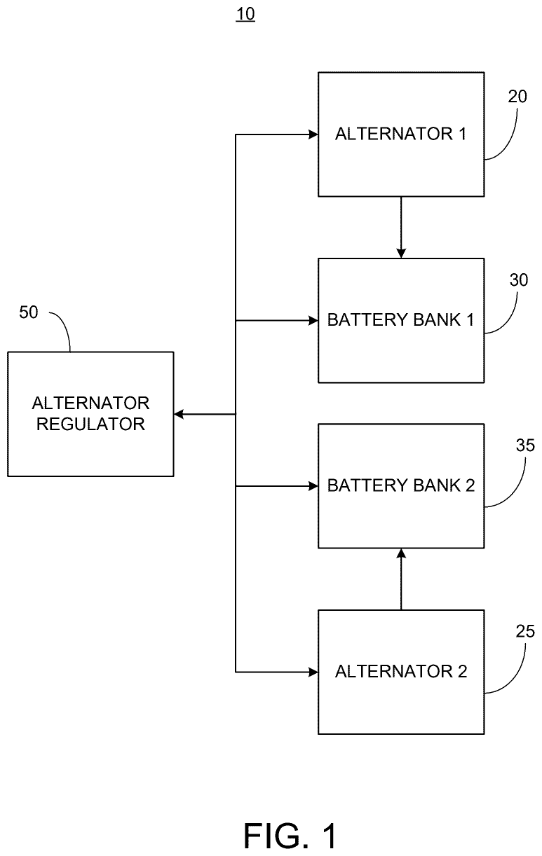

FIG. 1 shows a first implementation 10 of the present invention wherein a vehicle includes a first alternator 20, a second alternator 25, a first battery bank 30, a second battery bank 35, and an alternator regulator 50. As described in more detail below, the alternator regulator 50 regulates the power from the first alternator 20 to the first battery bank 30, regulates the power from the second alternator 25 to the second battery bank 35, and manages and charges the first and second battery banks 30 and 35. Each of the first battery bank 30 and the second battery bank 35 may have one or more batteries. The first battery bank 30 may have batteries with different chemistries (lead acid, lithium, etc.) than those of the second battery bank 35 and may have different operating voltages (12-48V).

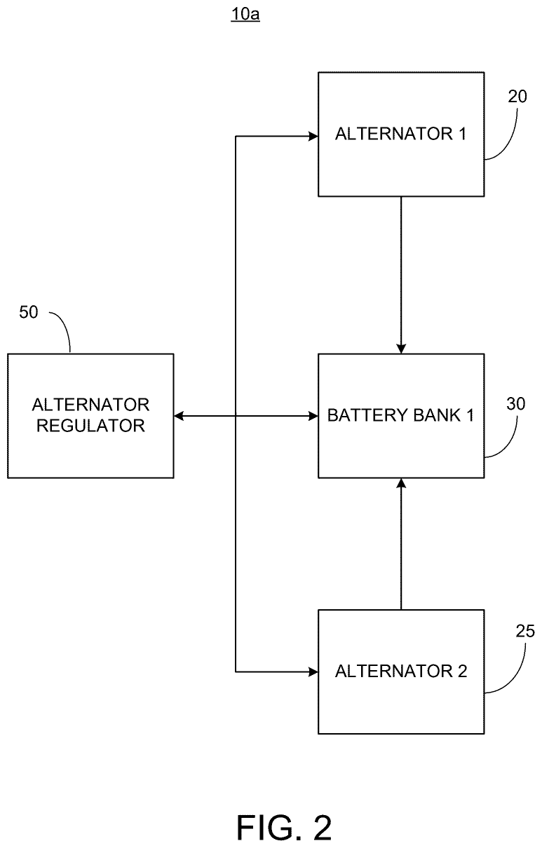

FIG. 2 shows a second implementation 10a of the present invention wherein the vehicle includes a first alternator 20, a second alternator 25, a first battery bank 30, and an alternator regulator 50. Thus, the second implementation 10a differs from the first implementation 10 in that it does not include the second battery bank 35. As described in more detail below, the alternator regulator 50 regulates the power from the first alternator 20 to the first battery bank 30, regulates the power from the second alternator 25 to the first battery bank 30, and manages and charges the first battery bank 30.

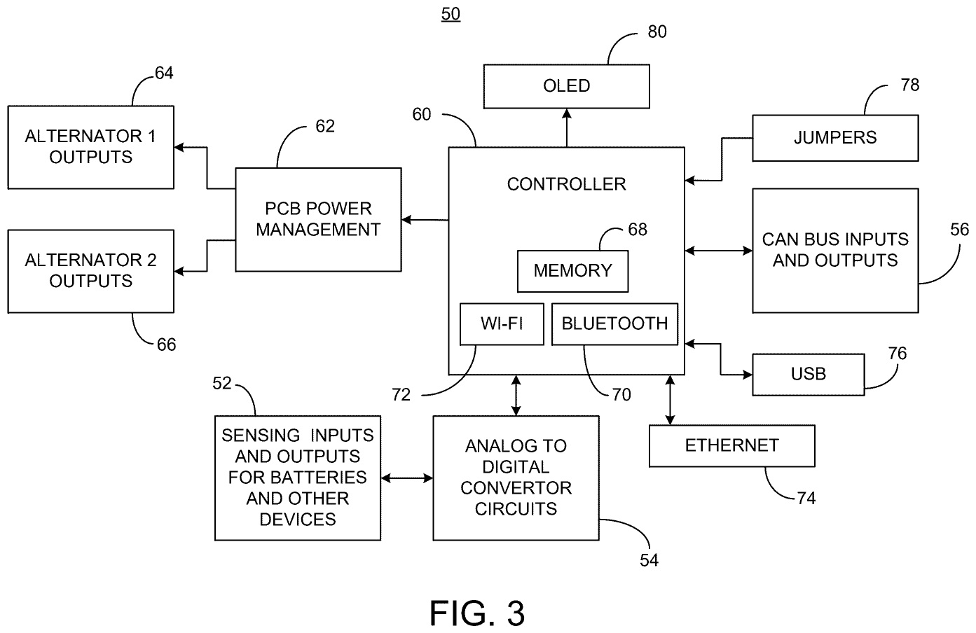

FIG. 3 shows an example of the alternator regulator 50. The regulator 50 may include a plurality of input ports and output ports 52, which are described in more detail below. Because some of the signals received or sent from these ports 52 are analog, the regulator 50 may include one or more analog to digital convertor circuits 54. Signals may also be sent or received via a CAN bus input and output port 56. The input signals may be received and monitored by a controller 60. The input signals may include alternator operating data from both of the two alternators 20 and 25 and battery data from the at least one battery bank 30, 35.

The CAN bus input and output port 56 may be CAN 2.0 and FD with compatibility for RV-C, NMEA 2000, and Victron. The CAN bus port 56 may allow connection and compatibility with battery management systems (BMS) via RV-C.

The alternator operating data may include alternator temperature, alternator RPM, alternator voltage, and alternator current of each of the two alternators 20 and 25. The battery data may include battery temperature, battery voltage, battery current, battery state of charge, and battery chemistry of each of the at least one battery bank 30, 35.

The regulator may include a PCB power management circuit 62 that is controlled by the controller 60 to generate outputs to the first and second alternators 20 and 25 via first alternator outputs 64 and second alternator outputs 66, respectively. The controller 60 is configured to independently regulate each of the two alternators 20 and 25 in response to the alternator operating data and the battery data and to manage and charge the at least one battery bank 30, 35 in response to the battery data. The controller 60 may be further configured to adjust charging voltage and current supplied by the alternators 20, 25 to the at least one battery bank 30, 35 based on one or more of: the alternator temperatures, the alternator RPMs, the battery temperature, the battery voltage, the battery current, the battery state of charge, and the battery chemistry.

The controller 60 may be any form of controller whether integrated or made of discreet circuit components. In a preferred implementation, the controller 60 may be a Broadcom quad-core Cortex-A72 64-bit SoC with 2 GB RAM 68 and 16 GB eMMC Flash memory storage. The PCB power management circuit 62 may include 20 kHz synchronous buck converters and 100V MOSFETs for efficient power delivery to the alternators 20 and 25.

The regulator 50 may include connectivity options such as a Bluetooth® transceiver 70, a Wi-Fi transceiver 72, an Ethernet transceiver 74, and USB 76. The USB 76 may be USB-C and the Ethernet 74 may be Gigabit Ethernet. By providing these connectivity options, the regulator 50 may be configured via direct input or by uploading configuration files from a technician. Further, the regulator 50 may be configured to allow automatic over-the-air (OTA) firmware updates, white space customization for alternator loading, and a high output mode for maximum power deliver across the RPM range.

The regulator 50 is configured to intelligently adjust the field current of alternators 20 and 25 and monitor system parameters in order to prioritize alternators, balance load distribution, and optimize overall charging performance. It also features preset and customizable charging profiles, temperature compensation, and compatibility with battery management systems (BMS) via RV-C. As discussed below, the regulator 50 receives input from various sensors, including voltage, current, temperature, and RPM for each connected alternator 20 and 25. It utilizes a charging algorithm to regulate the output of each alternator independently, prioritizing alternators based on configurable parameters like engine load, battery state of charge, and temperature. The algorithm also actively balances load distribution among the alternators 20 and 25, ensuring optimal efficiency and extending the lifespan of both the alternators and the batteries. Additionally, the charging algorithm adjusts the voltage and current to each battery bank based on its chemistry, state of charge, and temperature. The controller 60 prevents the alternators from overheating by independently regulating the alternators in response to respective alternator temperature. Further, the controller 60 determines from the alternator RPM of each of the two alternators whether excess power is available and may be configured to charge the at least one battery bank only when excess power is available.

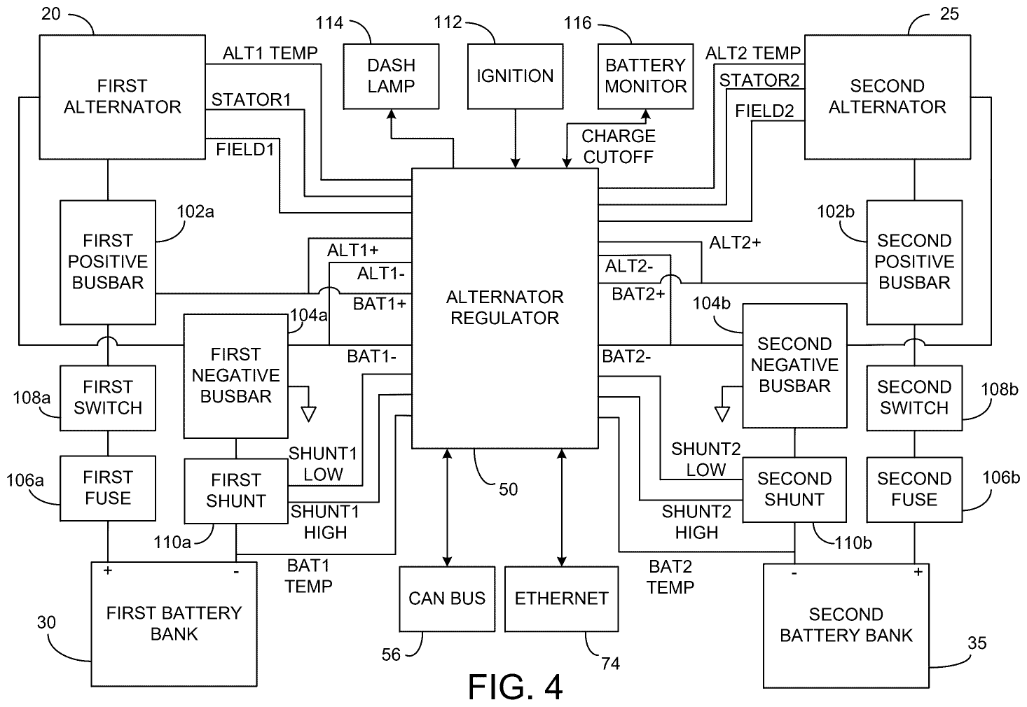

FIG. 4 shows an example of the connections with the regulator 50. As shown, a positive terminal of the first alternator 20 is connected to a first positive busbar 102a and a negative terminal of the first alternator 20 is connected to a first negative busbar 104a. A positive terminal of the first battery bank 30 is connected to the first positive busbar 102a via a first fuse 106a and a first switch 108a, and a negative terminal of the first battery bank 30 is connected to the first negative busbar 104a via a first shunt 110a. Similarly, a positive terminal of the second alternator 25 is connected to a second positive busbar 102b and a negative terminal of the second alternator 25 is connected to a second negative busbar 104b. A positive terminal of the second battery bank 35 is connected to the second positive busbar 102b via a second fuse 106b and a second switch 108b, and a negative terminal of the second battery bank 35 is connected to the second negative busbar 104b via a second shunt 110b.

The inputs that may be coupled to the input ports 52 of the regulator 50, include the following alternator connections:
ALT1 TEMP connects to a temperature sensor of the first alternator 20;
ALT1− provides ground to the regulator 50 and connects to the first negative busbar 104a or the negative ground terminal of the first alternator 20;
ALT1+supplies power for the alternator field and connects to the first positive busbar 102a or the positive terminal of the first alternator 20;
FIELD1 carries field current between the regulator 50 and first alternator 20;
STATOR1 provides a signal for the RPM of the first alternator 20 or the associated engine RPM and may connect to the stator (AC) output of the first alternator 20 or splice into the tachometer output;
BAT1 TEMP connects to a temperature sensor of the first battery bank 30;
BAT1− connects to the first negative busbar 104a or the negative terminal of the first battery bank 30;
BAT1+ connects to the first positive busbar 102a or the positive terminal of the first battery bank 30;
SHUNT1 HIGH connects to the high side of the first shunt 110a, toward the first battery bank 30;
SHUNT1 LOW connects to the low side of the first shunt 110a, toward the first negative busbar 104a;
ALT2 TEMP connects to a temperature sensor of the second alternator 25;
ALT2− provides ground to the regulator 50 and connects to the second negative busbar 104b or the negative ground terminal of the second alternator 25;
ALT2+ supplies power for the alternator field and connects to the second positive busbar 102b or the positive terminal of the second alternator 25;
FIELD2 carries field current between the regulator 50 and second alternator 25;
STATOR2 provides a signal for the RPM of the second alternator 25 or the associated engine RPM and may connect to the stator (AC) output of the second alternator 25 or splice into the tachometer output;
BAT2 TEMP connects to a temperature sensor of the second battery bank 35;
BAT2− connects to the second negative busbar 104b or the negative terminal of the second battery bank 35;
BAT2+ connects to the second positive busbar 102b or the positive terminal of the second battery bank 35;
SHUNT2 HIGH connects to the high side of the second shunt 110b, toward the second battery bank 35;
SHUNT2 LOW connects to the low side of the second shunt 110b, toward the second negative busbar 104b;
IGNITION provides switched power to the regulator 50 (8-60V). To power regulator only when an engine is running, the IGNITION port 112 is connected to an ignition switch, an oil pressure switch, or a similar circuit. For always-on battery monitoring while ensuring the alternator(s) is (are) engaged only when ignition is on, connect ignition wire to a positive bus bar or dedicated switch and connect charge cut-off wire to the ignition circuit;
DASH LAMP provides a ground path to activate a warning light or audible alarm 114 in the event of a fault condition; and
CHARGE CUTOFF provides a configurable function to stop charging when the signal line crosses an adjustable trigger voltage level (e.g., 2V) and may connect to a battery monitor 116.

The ALT1 TEMP and ALT2 TEMP inputs improve efficiency and protect the respective first and second alternators 20 and 25 by allowing the controller 60 to regulate the field outputs based on alternator temperatures. The BAT1 TEMP and BAT2 TEMP inputs allow the controller 60 to adjust the battery charging voltage based on battery temperature, which can be critical for lithium batteries in cold climates.

The BAT1−, BAT2−, BAT1+ and BAT2+ inputs improve charging accuracy by allowing the controller 60 to monitor the voltages at the battery banks' negative busbars 104a, 104b or negative terminals and the battery banks' positive busbars 102a, 102b or positive terminals. The BAT1− and BAT2− inputs may be connected to the same negative terminal post as the ground cable in multi-battery bank setups.

The SHUNT1 and SHUNT2 inputs allow the controller 60 to measure the current flow for charging optimization and battery health. If measuring the alternator current instead of battery current, the first and second shunts 110a and 110b may be connected to the positive wire and aligned with the battery shunt high toward the positive busbar. In that configuration, the first shunt 110a measures the current of the first alternator 20 and the second shunt 110b measures the current of the second alternator 25.

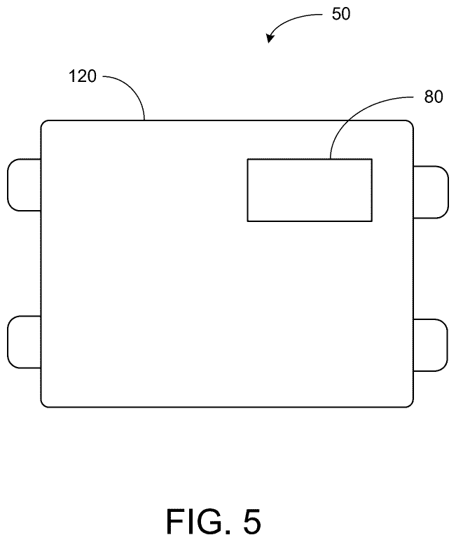

FIG. 5 shows a top view of the regulator 50. As shown, it may include an enclosure 120 in which all of the components of FIG. 3 are disposed. The enclosure 120 may provide a compact, corrosion-proof ABS enclosure with a conformal coated PCB. A display 80, such as an OLED display, may be provided in the enclosure 120 to display various data. The input and output ports may be accessible along the sides of the enclosure 120. A plurality of jumpers 78 (FIG. 3) may be accessible for setting various configuration options.

According to another embodiment, a cloud-based system is provided that is designed to provide advanced monitoring, historical data analysis, remote configuration, and management capabilities for remote alternator regulators (such as the alternator regulator 50 described above). Its cloud architecture ingests, processes, stores, and presents complex time-series and event data from potentially numerous remote alternator regulators, even those lacking persistent real-time clocks. It enables various user roles (End Users, Installers, OEMs, Admins) to remotely investigate historical performance, diagnose faults by correlating system parameters with events, optimize configurations, and manage remote alternator regulators for fleets of vehicles. The platform utilizes a scalable cloud infrastructure, employing distinct storage solutions optimized for different data types (metadata/events vs. time-series measurements), to handle large datasets and provide sophisticated analysis tools via a web-based interface. Key features include data session stitching for devices without real-time clocks, interactive time-series visualization with event overlays (faults, configuration changes), detailed fault analysis snapshots, statistical summaries, remote configuration deployment, and role-based access control.

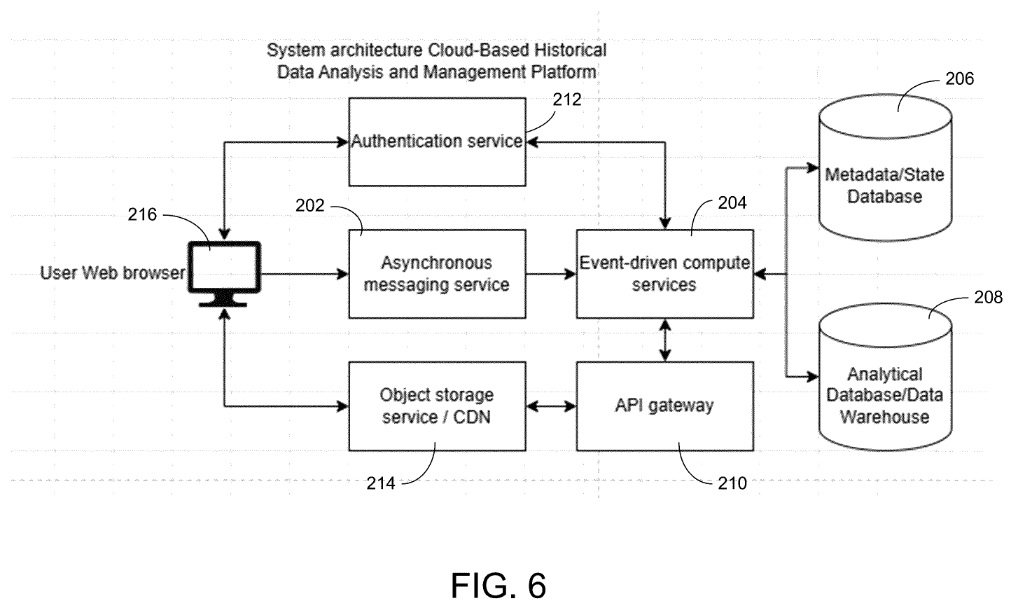

An example of the system architecture is shown in FIG. 6. The system utilizes a cloud- native architecture designed for scalability and reliability. Data ingestion occurs via an asynchronous messaging service 202 receiving data payloads (e.g., alternator regulator data in a structured format like JSON) via secure network protocols (e.g., HTTPS) from remote regulator devices 50. Event-driven compute services 204 (e.g., serverless functions) are triggered by incoming messages to process the data. This processing includes validating payloads, writing device status, metadata, configuration history, and fault events to a database 206 optimized for transactional metadata and state management (e.g., a NoSQL document database), and streaming historical time-series measurements (voltages, currents, temperatures, SoC, etc.) into a scalable analytical database or data warehouse 208 optimized for querying large volumes of time-series data (potentially utilizing partitioning or columnar storage). A backend API, built using compute services and secured by an API gateway 210, serves data to the frontend. The API queries the metadata/state database 206 for current status, configuration, recent events, and user data, and queries the analytical database 208 for historical time-series data required for analysis. User authentication and authorization are managed by a dedicated authentication service 212 or identity provider, supporting role-based access control. The user interface 216 is a web application served statically from an object storage service 214 via a Content Delivery Network (CDN) for efficient global delivery. Infrastructure may be managed programmatically using appropriate tools.

The components of the system include:
Messaging Service 202: Provides durable, asynchronous message queuing for decoupling data ingestion from processing, handling bursts of data.
Event-Driven Compute Services 204: Executes backend logic in response to events (like incoming messages), scaling automatically based on load. Used for data processing and API endpoints.
Metadata/State Database 206: Stores frequently accessed, relatively small data items like device status, current configuration, user profiles, roles, permissions, and event summaries. Optimized for quick lookups and updates.
Analytical Database/Data Warehouse 208: Stores large volumes of historical time-series data. Optimized for complex analytical queries over large date ranges, potentially supporting partitioning and aggregation.
API Gateway 210: Provides a secure, managed entry point for all backend API calls, handling request routing, authentication enforcement, rate limiting, and monitoring.
Authentication Service 212: Manages user identities, login/signup processes, and provides mechanisms for verifying user credentials and roles/permissions.
Object Storage Service & CDN 214: Provides durable storage for static web assets (HTML, CSS, JS) and delivers these assets quickly to users worldwide via edge locations.

In operation, the remote alternator regulators 50 periodically send status, measurement, and event data to the designated messaging service 202 endpoint. The event-driven compute functions process this data, storing it appropriately in the respective databases (metadata/state 206 vs. analytical 208). A processing step involves data session stitching: for regulators lacking a persistent real-time clock (where timestamps might reset), the cloud platform associates incoming data batches with unique sessions and uses cloud ingestion timestamps or timestamps derived from reliable external sources (relayed by the regulator) to establish a chronological order across multiple sessions. Users interact with the platform via the web UI 216. After authenticating via the authentication service 212, they can select devices they have access to. For analysis, users select a device and a time range. The frontend requests historical data from the backend API (via the API gateway 210). The API queries the analytical database 208, potentially returning aggregated data for long ranges or finer-grained data for zoomed-in views. Users can plot multiple parameters on interactive charts (supporting zoom, pan, tooltips), view a filterable list of fault events, see detailed parameter snapshots at the time of a fault, and view markers indicating when configuration changes occurred, overlaid on the charts. For remote configuration, users with appropriate permissions can view current settings (fetched from the metadata/state database 206 via the API gateway 210), modify them in the UI 216, and save/deploy the changes. Saving triggers an API call which updates the desired configuration in the metadata/state database 206 and potentially sends a command back to the regulator device 50 via a push mechanism (e.g., another message queue) or relies on the regulator device polling for updates. Fleet management features allow authorized users to view aggregated data or deploy configurations across multiple regulator devices 50.

The user interface (UI) 216 may be a web-based graphical user interface accessible via standard web browsers. Key components include:
Dashboard/Device List: Shows devices accessible to the user, their online status, and key summary metrics. View varies based on user role.
Analysis Page: Core interface for historical investigation. Features include device selection, flexible time-range selection, customizable multi-series interactive charts, a sortable/filterable event log (faults, configuration changes) with detailed snapshots, statistical summaries, and data export functionality. Configuration change events can be visually overlaid on the time-series charts.
Configuration Page: Allows viewing and remote modification/deployment of regulator settings for authorized users. May include template management.
Fleet Management Pages: UI for managing device fleets, deploying configurations, and viewing fleet-wide analytics.
User/Access Management: Interfaces for managing user profiles and controlling access permissions.

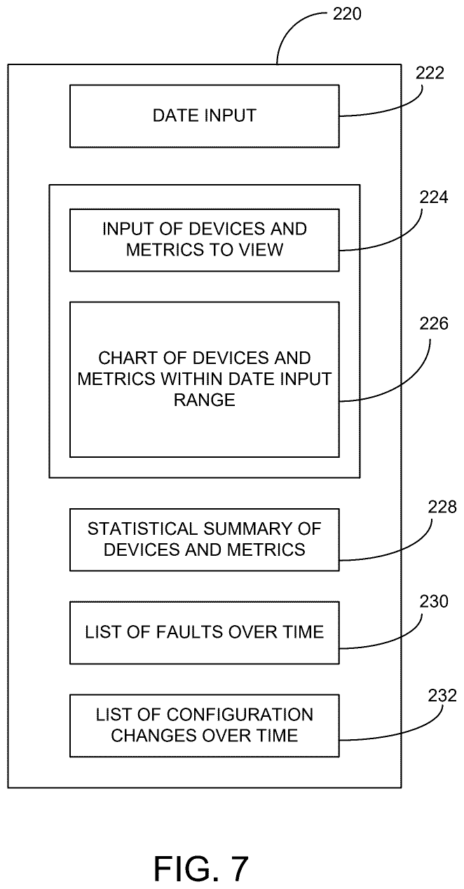

An example of the Analysis Page 220 is shown in FIG. 7. The Analysis Page 220 may provide flexible time-range selection 222, device and metrics selection 224, customizable multi-series interactive charts showing devices and metrics within the input date range 226, statistical summaries 228, a sortable/filterable event log of faults 230, a sortable/filterable event log of configuration changes with detailed snapshots 232, and data export functionality.

The platform architecture supports features such as configurable data retention policies, exporting of data for offline use, statistical summaries, comparative analysis tools, and potential future extensions like automated alerting with notifications and calculation/display of derived performance KPIs.

It should be noted that the alternator regulators that are remotely monitored and configured by the system may take any form and do not need to be capable of regulating more than one alternator. In general, the alternator regulators would have some form of connectivity to the Internet whether by wired (Ethernet) or wireless (Wi-Fi).

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above are merely for illustrative purposes and not intended to limit the scope of the device, which is defined by the following claims as interpreted according to the principles of patent law, including the Doctrine of Equivalents.

What is claimed is:

1. A regulator for regulating power supplied from two alternators to at least one battery bank, the regulator comprising:
an enclosure;
a plurality of input ports on the enclosure for receiving alternator operating data from both of the two alternators and for receiving battery data from the at least one battery bank; and
a controller disposed in the enclosure and coupled to the plurality of input ports, the controller configured to:
independently regulate each of the two alternators in response to the alternator operating data and the battery data; and
manage and charge the at least one battery bank in response to the battery data.

2. The regulator of claim 1, wherein the at least one battery bank includes a first battery bank and a second battery bank, wherein the controller is further configured to independently manage charging of the first and second battery banks.

3. The regulator of claim 2, wherein the first battery bank has a different chemistry than the second battery bank.

4. The regulator of claim 2, wherein the first battery bank has a different voltage than the second battery bank.

5. The regulator of claim 1, wherein the alternator operating data includes alternator temperature of each of the two alternators, wherein the controller prevents the alternators from overheating by independently regulating the alternators in response to respective alternator temperature.

6. The regulator of claim 1, wherein the alternator operating data includes alternator RPM of each of the two alternators, wherein the controller determines from the alternator RPM of each of the two alternators whether excess power is available and charges the at least one battery bank only when excess power is available.

7. The regulator of claim 1, wherein the alternator operating data includes alternator temperature, alternator RPM, alternator voltage, and alternator current of each of the two alternators, wherein the battery data includes battery temperature, battery voltage, battery current, battery state of charge, and battery chemistry, and wherein the controller is further configured to adjust charging voltage and current supplied by the alternators to the at least one battery bank based on one or more of: the alternator temperatures, the alternator RPMs, the battery temperature, the battery voltage, the battery current, the battery state of charge, and the battery chemistry.

8. The regulator of claim 1 and further comprising:
a CAN bus port on the enclosure for connecting to a vehicle's CAN bus,
wherein the controller is further configured to send and receive CAN data over the CAN bus.

9. The regulator of claim 1 and further comprising:
a transceiver disposed in the enclosure for communicating analytical information with a remote device, the transceiver being one of a Wi-Fi transceiver, a Bluetooth® transceiver, or an ethernet transceiver.

10. The regulator of claim 1 and further comprising:
a memory disposed in the enclosure for storing historical data including one or more of performance trends and event logs.

11. A regulator for regulating power supplied from two alternators to a first battery bank and a second battery bank, the regulator comprising:
an enclosure;
a plurality of input ports on the enclosure for receiving alternator operating data from both of the two alternators and for receiving battery data from the two battery banks; and
a controller disposed in the enclosure and coupled to the plurality of input ports, the controller configured to:
independently regulate each of the two alternators in response to the alternator operating data and the battery data; and
independently manage and charge each of the first and second battery banks in response to the battery data.

12. The regulator of claim 11, wherein the first battery bank has a different chemistry than the second battery bank.

13. The regulator of claim 11, wherein the first battery bank has a different voltage than the second battery bank.

14. The regulator of claim 11, wherein the alternator operating data includes alternator temperature of each of the two alternators, wherein the controller prevents the alternators from overheating by independently regulating the alternators in response to respective alternator temperature.

15. The regulator of claim 11, wherein the alternator operating data includes alternator RPM of each of the two alternators, wherein the controller determines from the alternator RPM of each of the two alternators whether excess power is available and charges the battery banks only when excess power is available.

16. The regulator of claim 11, wherein the alternator operating data includes alternator temperature, alternator RPM, alternator voltage, and alternator current of each of the two alternators, wherein the battery data includes battery temperature, battery voltage, battery current, battery state of charge, and battery chemistry, and wherein the controller is further configured to adjust charging voltage and current supplied by the alternators to the battery banks based on one or more of: the alternator temperatures, the alternator RPMs, the battery temperature, the battery voltage, the battery current, the battery state of charge, and the battery chemistry.

17. The regulator of claim 11 and further comprising:
a CAN bus port on the enclosure for connecting to a vehicle's CAN bus,
wherein the controller is further configured to send and receive CAN data over the CAN bus.

18. The regulator of claim 11 and further comprising:
a transceiver disposed in the enclosure for communicating analytical information with a remote device, the transceiver being one of a Wi-Fi transceiver, a Bluetooth® transceiver, or an ethernet transceiver.

19. A cloud-based system for managing remote alternator regulators, the system comprising:
an asynchronous messaging system for receiving time-series and event data from the remote alternator regulators;
a metadata and device state database for storing frequently accessed data items like regulator device status, current configuration, user profiles, roles, permissions, and event summaries;
a scalable analytical database for storing historical time-series measurements received from the remote alternator regulators;
event-driven compute services triggered by incoming messages received by the asynchronous messaging system to process the time-series and event data by validating payloads, writing regulator device status, configuration history, and fault events to the metadata and device state database, the event-driven compute services further configured to store historical time-series measurements into the scalable analytical database, wherein the event-driven compute services are additionally configured for chronologically ordering data sessions for any of the remote alternator regulators that lack persistent time references; and
an API gateway for providing remote viewing and deployment of configuration settings to the alternator regulators, the API gateway providing remote viewing in which visualization of multiple parameters, correlation of performance data with logged events including fault conditions and configuration changes, display of system parameters proximate to event occurrences, and data export are provided through a user interface.

20. The system of claim 19 and further comprising an authentication service for providing access control to the regulator data stored in the databases.
